(19) United States
(12) Patent Application Publication
(10) Pub. No.: US 2010/0046038 A1
(43) Pub. Date: Feb. 25, 2010

(54) IMAGE PROCESSING APPARATUS

(75) Inventors: Hideyuki Matsuda, Suita-shi (JP); Kazumi Sawayanagi, Itami-shi (JP); Toshihiko Otake, Ikeda-shi (JP); Hiroki Tajima, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 12/542,761

(22) Filed: Aug. 18, 2009

(30) Foreign Application Priority Data
Aug. 22, 2008 (JP) 2008-213960

(51) Int. Cl. H04N 1/00

(52) U.S. Cl. 358/434

(57) ABSTRACT

In the case where detection is made that a transmission button 13f displayed on an upload control screen 13a acquired from a web server is operated via a browser 21a having a function of uploading a file onto a web server 2, if a file name display field 13g is blank, a scanner 12 is instructed to start scanning an image of a document via operation of a scanning start button 16 for instructing to start scanning the image of the document. Then, image data output by the scanner 12 is digitized by a data digitization block 15f, and the digitized data is uploaded onto the web server 2. This enhances user convenience for uploading a file onto a web server using a browser having an upload function.

This application is based on application No. 2008-213960 filed in Japan, the content of which is hereby in incorporated reference.

### BACKGROUND OF THE INVENTION

(1) Field of the Invention

The present invention relates to an image processing apparatus such as an MFP (Multi Function Peripheral) equipped with a browser having a function of uploading a file onto a server.

(2) Related Art

An MFP functioning as a copier, a printer, and the like is connected with a server via a network such as a LAN and the Internet to upload a file onto the server and store the file in the server.

According to the structure disclosed in Japanese Patent Application Publication No. 2006-254057, in order to upload a file of image data scanned by an image scanning apparatus onto a web server, an upload instruction necessary for uploading the file is extracted from descriptive information on an operation screen displayed as a web page, and the extracted upload instruction is stored in a storage apparatus. Then, the descriptive information is reconfigured based on the upload instruction stored in the storage apparatus to upload the file. Also, this Patent Application Publication discloses the structure in which a transmission file is generated based on a file generated as a result of scan processing and the descriptive information, and the generated transmission file is automatically uploaded onto the web server by a transmission unit. However, according to the above structure, it is necessary for a user to input the upload instruction such as a transmission destination in the operation screen displayed as the web page, and store the input upload instruction in the storage apparatus. This causes a bothersome problem for the user to perform such input operations.

According to the structure disclosed in Japanese Patent Application Publication No. 2006-166292, a user interface is displayed using a browser installed in an MFP, information of a scanning apparatus is registered in a storage server via the displayed user interface, and sentences of a document scanned by the scanning apparatus is transmitted to the storage server. However, this structure also causes a user to set information necessary for uploading using the browser and register the set information. This causes a bothersome problem for the user to perform such setup operations for registration.

Unlike these structures disclosed in the above Patent Application Publications, a PC (personal computer) is equipped with a browser having an upload function in order to simplify user operations for uploading a file onto a web server. The browser installed in such a PC acquires an upload control screen for uploading a file from a web server to display the acquired upload control screen on a display panel. On the upload control screen, a reference button that is operated for selecting a file to be uploaded, a file name display filed in which a file name of the selected file is input, and a transmission button that is operated for instructing to upload the file are displayed.

When a user operates (clicks) the reference button displayed on such an upload control screen, a dialog box of the file opens to enable the user to select a file to be uploaded. Then, when the user selects a desired file from the dialog box, data of the selected file is converted into digitized data in a predetermined format, and a file name of the selected file is displayed on a file name display field. Then, the user operates the transmission button, and the file stored in the PC having the file name displayed on the file name display field is uploaded onto the server.

As described above, with use of the browser having the upload function, the user simply operates the reference button displayed on the upload control screen to specify a file and then operates the transmission button, file data that is digitized data stored in the PC is converted into a predetermined format and uploaded onto the web server. Therefore, it is unnecessary for the user to perform operations for specifying an upload destination and the like.

By installing a browser having such an upload function in an MFP, it is possible to upload a file stored in the MFP onto a server. Also, since the MFP is equipped with an image scanning apparatus, it is also possible to upload image data scanned by the image scanning apparatus onto the server using the above browser, as well as the stored file.

In order to upload the image data scanned by the image scanning apparatus onto the server using the browser, the user firstly operates the reference button displayed on the upload control screen. Then, the user places a document on the image scanning apparatus, sets a scan condition of the image scanning apparatus for scanning an image of the document, and instructs the image scanning apparatus to start scanning the image by operating the start button. In accordance with the instruction, the image scanning apparatus performs the scanning to generate image data of the document. The generated image data is converted into digitized data in a predetermined format (for example, PDF) so as to be uploaded onto the server. After completion of the conversion into the digitized data, the browser is notified that a file of the converted digitized data becomes ready for being uploaded onto the server, and then the digitized data is displayed on the upload control screen. When the user operates the transmission button displayed on the upload control screen in such a status, the file of the digitized data is uploaded onto the server by the browser.

In this way, in order to cause the browser to upload data of an image of a document onto a server, the user needs to operate the reference button and instruct the image scanning apparatus to scan the image of the document. Then, the user needs to wait for completion of conversion of the image data into digitized data in a predetermined format, and then operate the transmission button. Therefore, there occurs a problem that since the user needs to operate the transmission button, the user cannot get away from the MFP until conversion of the image data into the digitized data has completed. There is a case that an MFP requires a comparatively long period to perform scanning of the image of the document by the image scanning apparatus and conversion of the image data into digitized data. In such a case, the user cannot get away from the MFP for the long period.

### SUMMARY OF THE INVENTION

The present invention is made to solve the above problem, and its object is to provide an image processing apparatus capable of enhancing convenience of users for uploading a file onto a web server with use of a browser having an upload function.

In order to achieve the above object, the image processing apparatus relating to the present invention is an image processing apparatus comprising: a browser operable to acquire, from a web server, an upload control screen including a transmission receiving part that is operated for issuing an upload instruction, and upload digitized data in a predetermined format onto the web server via the operation of the transmission receiving part; a storage that stores digitized data of a file; an image scanner operable to scan an image of a document to generate digitized data of the image; a display operable to display thereon the upload control screen; a controller operable to, by using the operation of the transmission receiving part as a trigger, convert the digitized data of the file or the digitized data of the image into the predetermined format, and issue the upload instruction to the browser to upload the digitized data of the file or the digitized data of the image in the predetermined format.

According to one aspect of the present invention, by operating the transmission receiving part displayed on the upload control screen acquired by the browser having a function of uploading file data, scanning of an image by the image scanner, digitization of image data generated by the image scanner or file data stored in the storage, and uploading of the digitized data onto the web server are automatically performed. Accordingly, the user does not need to wait near the image processing apparatus until digitization of the image data has completed. This dramatically enhances the user convenience.

It is preferable that after the transmission receiving part is operated, the controller acquires the digitized data of the image or the digitized data of the file, and performs the conversion.

It is preferable that the controller is set in advance to perform one of processing of cancelling the upload instruction, processing instructed by a response e-mail to an e-mail transmitted to a predetermined authenticated user, and processing of transferring the digitized data of the image or the digitized data of the file converted into the predetermined format to the predetermined authenticated user.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the drawings:

FIG. 1 is a schematic diagram showing a communication system that uses an MFP that is an image processing apparatus relating to embodiments of the present invention;

FIG. 2 is a block diagram showing the structure of the MFP;

FIG. 3 shows a display example of an upload control screen displayed by a browser provided in the MFP;

FIG. 4 shows a display example of a scan condition setup input screen displayed on a display panel of the MFP;

FIG. 5 shows a display example of a box data loading setup input screen displayed on the display panel of the MFP;

FIG. 6 is a flow chart showing a procedure of upload processing according to a first embodiment performed by the MFP;

FIG. 7 is a flow chart showing a subroutine of automatic timing adjustment processing of the upload processing performed by the MFP;

FIG. 8 is a flow chart showing a procedure of upload processing according to a second embodiment performed by the MFP;

FIG. 9 is a flow chart showing a procedure of upload processing according to a third embodiment performed by the MFP;

FIG. 10 shows a display screen for initializing processing relating to digitized data in a case where the digitized data is not uploaded in the upload processing performed by the MFP;

FIG. 11 shows a display screen for performing file transfer setup to initialize the processing relating to the digitized data;

FIG. 12 is a flow chart showing a procedure of the processing relating to the digitized data;

FIG. 13 is a flow chart showing a procedure of the processing relating to the digitized data;

FIG. 14 is a schematic diagram schematically showing an example of the processing relating to the digitized data; and

FIG. 15 is a schematic diagram schematically showing another example of the processing relating to the digitized data.

### DESCRIPTION OF PREFERRED EMBODIMENTS

The following describes preferred embodiments of an image processing apparatus relating to the present invention with reference to the drawings.

<Structure of Image Processing Apparatus>

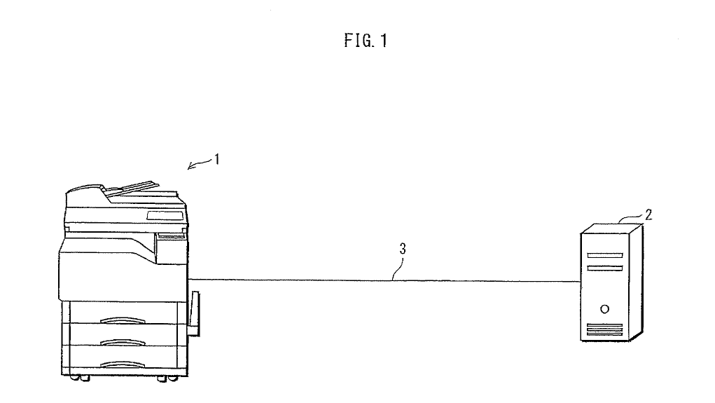

FIG. 1 is a schematic diagram showing the structure of a communication system that uses an MFP that is an example of an image processing apparatus according to embodiments of the present invention. The MFP 1 is connected with a web server 2 via a network 3. The MFP 1 includes a browser having a function of uploading a file onto the web server 2.

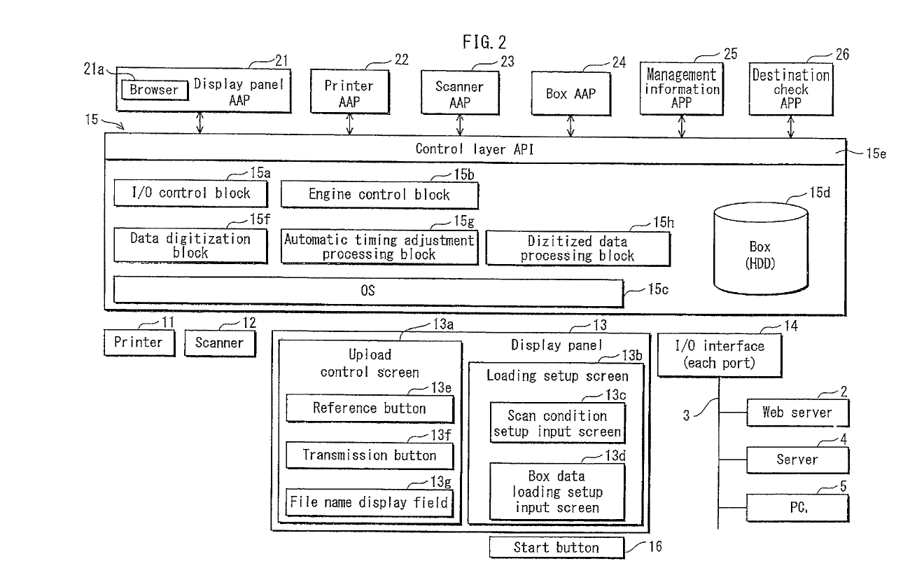

FIG. 2 is a block diagram showing the structure of the MFP 1. The MFP 1 includes a printer 11 for performing image formation processing, a scanner 12 for scanning an image of a document, a display panel 13, an I/O (input/output) interface 14 connected with the network 3 or the like for inputting/outputting various digitized data, and a control unit 15 for controlling these functional blocks.

The scanner 12 scans, for example, an image of a document transmitted by an ADF (Auto Document Feeder) or an image of a document disposed on a platen, and generates image data corresponding to the scanned image. The printer 11 forms an image based on the image data of the document scanned by the scanner 12 or based on the image data input by the I/O interface 14, in accordance with a well-known electro photographic system. The I/O interface 14 is connected with the web server 2, a server 4 other than the web server 2, a personal computer (PC) 5, and the like. The display panel 13 is composed of a touch input type LCD panel for example, and displays various information. Also, the display panel 13 is capable of issuing a predetermined instruction to the control unit 15 by a user touching a predetermined position of a display screen on which information is displayed.

The control unit 15 includes, as a storage unit, a box 15d for storing various digitized data. The box 15d is for example an HDD, and stores, for each file, various digitized data such as digitized image data scanned by the scanner 12. Each file stored in the box 15d has a file name.

Also, the control unit 15 includes an Operating System (OS) 15c for controlling various applications (APPs) input via a control layer Application Program Interface (API) 15e. The various applications are stored in a ROM not shown, for example. The various applications include a display panel APP 21 for controlling the display panel 13, a printer APP 22 for controlling the printer 11, a scanner APP 23 for controlling the scanner 12, a box APP 24 for controlling input/output data to/from the box 15d, a management information APP 25 for managing states of the printer 11 and the scanner 12, and a destination check APP 26 for checking a transmission destination of an e-mail.

The display panel APP 21 includes a browser 21a having a function of uploading a file onto the web server 2. The browser 21a acquires an upload control screen of the web server 2, and displays the acquired upload control screen on the display panel 13. The user operates the upload control screen, and a result, image data of a document scanned by the scanner 12 or file data stored in the box 15d is uploaded onto the web server 2.

The control unit 15 includes an I/O control block 15a for controlling data input/output to/from the I/O interface 14 and an engine control block 15b for operating the printer 11 and the scanner 12 under control of the printer APP 22 and the scanner APP 23.

Furthermore, the control unit 15 includes a data digitization block 15f, an automatic timing adjustment processing block 15g, and a digitized data processing block 15h. The data digitization block 15f converts file data scanned by the scanner 12 or file data stored in the box 15d into digitized data in a predetermined format (for example, PDF format) so as to be uploaded onto the web server 2 by the browser 21a. The automatic timing adjustment processing block 15g automatically adjusts a timing for instructing the browser 21a to upload data onto the web server 2 so as to conform to a predetermined timing. In a case where data digitized by the data digitization block 15f remains in the control unit 15 without being uploaded onto the web server 2, the digitized data processing block 15h performs predetermined processing on the digitized data.

Note that the display panel 13 displays an upload control screen 13a acquired from the web server 2 by the browser 21a and a loading setup screen 13b for setting scanning of an image of a document by the scanner 12 or loading of file data stored in the box 15d. On the upload control screen 13a displayed on the display panel 13, a reference button 13e, a transmission button 13f, and a file name display field 13g are displayed. The reference button 13e is operated by the user such that file data stored in the box 15d is uploaded onto the web server 2e, for example. The transmission button 13f is operated by the user to instruct to upload a file onto the web server 2. The file name display field 13g displays a file name of a file selected to be uploaded onto the web server 2. Also, on the loading setup screen 13b displayed on the display panel 13, a scan condition setup input screen 13c and a box data loading setup input screen 13d are displayed. The scan condition setup input screen 13c is operated by the user to set a scan condition of the scanner 12 for scanning an image of a document. The box data loading setup input screen 13d sets loading of file data stored in the box 15d.

Note that a start button 16 is output to the control unit 15. The start button 16 functions as an acquisition instruction unit that is operated by the user for instructing the printer 11 to start performing the image formation operations, instructing the scanner 12 to start scanning an image of a document, instructing to start loading file data stored in the box 15d, for example, so as to instruct to acquire image data or file data.

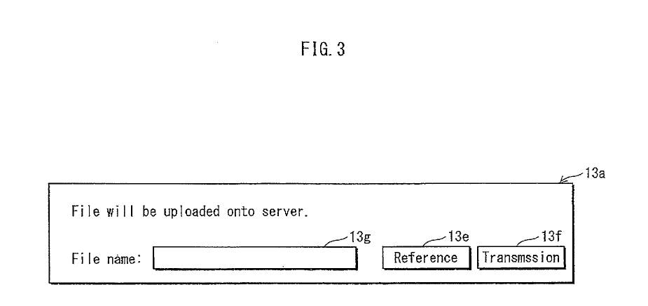

FIG. 3 shows an example of the upload control screen 13a displayed on the display panel 13. At the upper part of the upload control screen 13a, the message “File will be uploaded onto server.” is displayed so as to clarify that the upload job is instructed. At the lower part of the upload control screen 13a, the file name display field 13g, the reference button (reference reception unit) 13e, and the transmission button (transmission reception unit) 13f are displayed side by side in the horizontal direction.

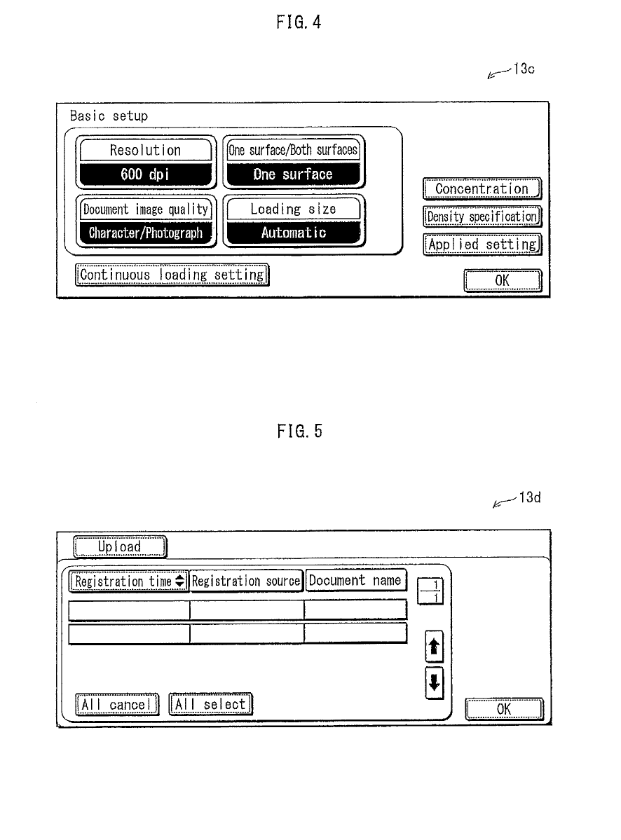

FIG. 4 shows an example of the scan condition setup input screen 13c displayed on the display panel 13. On the scan condition setup input screen 13c, a screen is displayed for inputting setup of the resolution, one surface or both surfaces of a document, the image quality of the document, the loading size, and the like. A button “OK BUTTON” that is operated on completion of the setup is also displayed on the scan condition setup input screen 13c.

FIG. 5 shows an example of the box data loading setup input screen 13d displayed on the display panel 13. On the box data loading setup input screen 13d, a dialog box of the file stored in the box 15d is opened, and a list of data file stored in the box 15d is displayed. A button “OK BUTTON” that is operated on completion of the setup is also displayed on the box data loading setup input screen 13d. It is possible to select and set a file to be uploaded from the displayed list.

### First Embodiment Relating to Upload Job

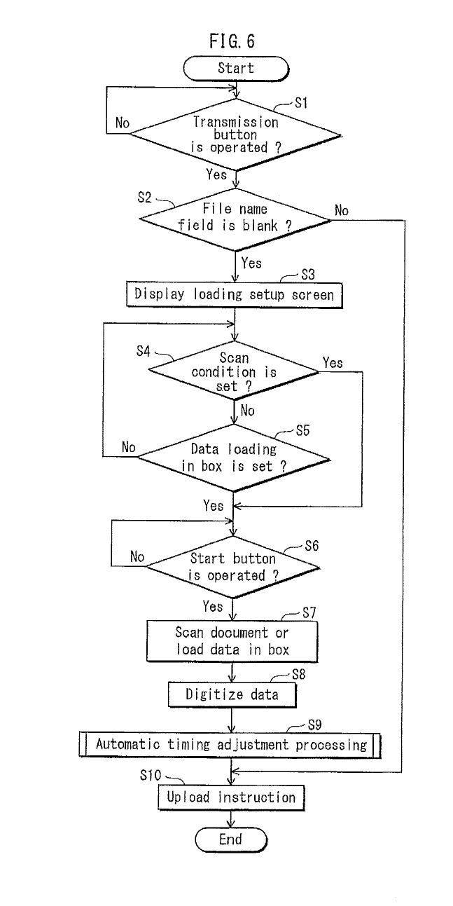

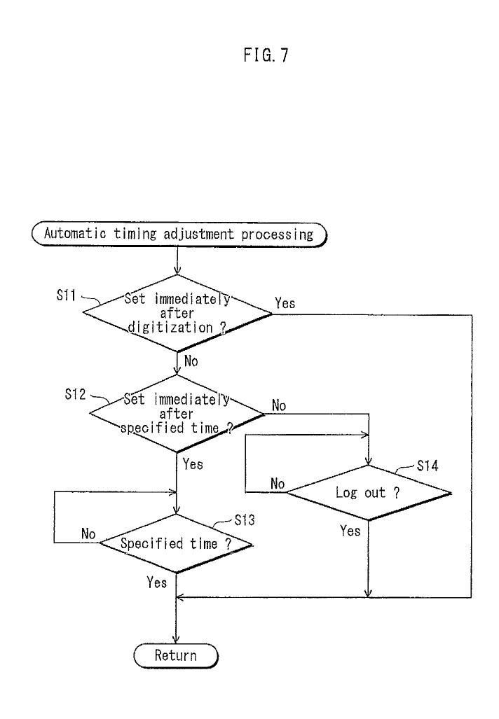

The following describes the first embodiment relating to an upload job, with use of the MFP 1 having such a structure, of uploading image data of a document scanned by the scanner 12 or data of a file stored in the box 15d onto the web server 2, with reference to a flow chart shown in FIG. 6.

In the present embodiment, in order to perform the upload job, the control unit 15 displays the upload control screen 13a shown in FIG. 3 acquired from the web server 2 by the browser 21a. In this case, when the reference button 13e displayed on the upload control screen 13a is operated, a dialog box of a file stored in the box 15d is displayed. This enables selection of a file to be uploaded, in the same way as a normal browser installed in a PC. When a file is selected by the user, the selected file is read from the box 15d, and is digitized by the data digitization block 15f. Then, a file name of the digitized data is displayed on the file name display field 13g. In such a display status, the user operates the transmission button 13f, and the digitized data of the file having the file name displayed on the file name display field 13g is uploaded onto the web server 2.

Compared with this, if detecting that the user operates the transmission button 13f without operating the reference button 13e (see Step S1 in FIG. 6, hereinafter the same shall apply), the control unit 15 judges whether the file name display field 13g displayed on the upload control screen 13a is blank (Step S2).

If a file name is displayed on the file name display field 13g (Step S2: NO), data that has been already digitized in a predetermined upload format such as PDF is stored. Accordingly, the flow proceeds to Step S10, and the control unit 15 instructs the browser 21a to upload the file onto the web server 2. Upon receiving the instruction, the browser 21a uploads the digitized data whose file name is displayed on the file name display field 13g onto the web server 2.

If the file name display field 13g displayed on the upload control screen 13a is blank (Step S2: YES), the loading setup screen 13b is displayed on the display panel 13 (Step S3). On the loading setup screen 13b, the scan condition setup input screen 13c and the box data loading setup input screen 13d are provided as described above. Until a scan condition of the scanner 12 for scanning an image of a document is set via the scan condition setup input screen 13c (Step S4), or until a desired data file stored in the box 15d is selected on the box data loading setup input screen 13d (Step S5), the control unit 15 is in a standby state.

If the scan condition of the scanner 12 for scanning the image of the document is set via the scan condition setup input screen 13c and the button “OK BUTTON” is operated (Step S4: YES), the flow proceeds to Step S6. The control unit 15 is in a standby state until the start button 16 is operated by the user. If the scan condition is not set via the scan condition setup input screen 13c (Step S4: NO) and a desired data file is selected on the box data loading setup input screen 13d and the button “OK BUTTON” is operated (Step S5: YES), the flow also proceeds to Step S6. The control unit 15 is in a standby state until the start button 16 is operated by the user.

Then, if the start button 16 is operated by the user (Step S6: YES), the flow proceeds to Step S7. If the scan condition of the scanner 12 for scanning the image of the document is set, the control unit 15 instructs the scanner 12 to scan the image of the document. Upon receiving the instruction, the scanner 12 scans the image of the document to generate image data corresponding to the image of the data, and outputs the generated image data to the control unit 15. In this way, the control unit 15 acquires the image data. Compared with this, if the scan condition of the scanner 12 for scanning the image of the document is not set and the file stored in the box 15d is set, the control unit 15 loads the set file data from the box 15d in Step S7. In this way, the control unit 15 acquires the file data.

The control unit 15 converts the image data scanned by the scanner 12 or the file data loaded from the box 15d into digitized data in a predetermined format (for example, PDF) so as to be uploaded onto the web server 2 by the browser 21a (Step S8).

The control unit 15 automatically adjusts a timing for instructing the browser 21a to upload data onto the web server 2 such that the data digitized in the predetermined format is uploaded at the predetermined timing set by the automatic timing adjustment processing block 15g (Step S9). Then, at the predetermined timing automatically adjusted by the automatic timing adjustment processing block 15g, the control unit 15 instructs the browser 21a to upload the digitized data onto the web server 2 (Step S10). Upon receiving the instruction, the browser 21a uploads the digitized data onto the web server 2.

In this way, according to the upload job shown in FIG. 6, the user (a) operates the transmission button 13f displayed on the upload control screen 13a, and (b) sets a scan condition of the scanner 12 for scanning the image of the document, or selects the data file stored in the box 15d, and (c) then operates the start button 16. Then, the image data generated as a result of scanning the image of the document by the scanner 12 or the file data loaded from the box 15d is automatically digitized, and the digitized data is uploaded onto the web server 2 by the browser 21a. Accordingly, the user does not need to set an upload condition such as an upload destination. Furthermore, the user does not need to wait near the MFP 1 until scanning of an image of a document by the scanner 12 starts and digitization of the image data ends, or until loading of the file data from the box 15d starts and digitization of the file data ends. Accordingly, compared with the structure of a conventional MFP in which the user can get away from the MFP only after the user waits for completion of digitization and then operates the transmission button, it is possible to reduce a waiting period of the user. This dramatically enhances the user convenience.

FIG. 7 is a flow chart showing the automatic timing adjustment processing performed in Step S9. The automatic timing adjustment processing block 15g provided in the control unit 15 automatically adjusts a timing of instructing the browser 21a to upload digitized data onto the web server 2 so as to conform to a predetermined timing set in advance by the user or the like. As an upload timing in this case, any one of the following times is set: a time immediately after data is digitized by the data digitization block 15f (Step S8 of the flowchart shown in FIG. 6); a time immediately after a specified time after data is digitized by the data digitization block 15f; and a time immediately after a time when the MFP 1 logs out due to completion of all the image processing operations instructed by the user such as the image scanning operation and the printing operation.

In the automatic timing adjustment processing, the automatic timing adjustment processing block 15g judges whether the timing of instructing the browser 21a to upload the file of the digitized data onto the web server 2 is set to be a time that is immediately after the data is digitized by the data digitization block 15f (see Step S11 in FIG. 7, hereinafter the same shall apply). If the timing is set to be the time that is immediately after digitization of the data (Step S11: YES), the automatic timing adjustment processing block 15g promptly ends the automatic timing adjustment processing, and the flow proceeds to Step S10 of the flow chart shown in FIG. 6. Then, the automatic timing adjustment processing block 15g instructs the browser 21a to upload the file onto the web server 2. Upon receiving the instruction, the browser 21a uploads the file onto the web server 2 immediately after the data is digitized by the data digitization block 15f.

Compared with this, if the timing of uploading the file is not set to be a time that is immediately after the data is digitized by the data digitization block 15f (Step S11: NO), the automatic timing adjustment processing block 15g judges whether the timing of uploading the file is set to be a time that is immediately after a specified time after digitization of the data (Step S12). If the timing is set to be the time that is immediately after the specified time (Step S12: YES), the automatic timing adjustment processing block 15g waits until the specified time comes (Step S13). When the specified time comes (Step S13: YES), the automatic timing adjustment processing block 15g ends the automatic timing adjustment processing. Then, the flow proceeds to Step S10 of the flow chart shown in FIG. 6, the control unit 15 instructs the browser 21a to upload the file onto the web server 2. Upon receiving the instruction, the browser 21a uploads the digitized file data onto the web server 2 immediately after the specified time after digitization of the data.

If the timing of uploading the digitized data is not set to be a time that is immediately after the specified time (Step S12: NO), the control unit 15 waits for the MFP 1 to log out, assuming that the timing of uploading the file is set to be a time that is immediately after the MFP 1 logs out (Step S14). Then, when the MFP 1 logs out (Step S14: YES), the control unit 15 ends the automatic timing adjustment processing, and the flow proceeds to Step S10 of the flow chart shown in FIG. 6. The control unit 15 instructs the browser 21a to upload the file data onto the web server 2. Upon receiving the instruction, the browser 21a uploads the digitized file data onto the web server 2 immediately after the MFP 1 logs out.

In this way, the upload instruction is issued to the browser 21a at a predetermined timing set in advance by the user. Accordingly, the user convenience of the upload job is much more enhanced.

### Second Embodiment Relating to Upload Job

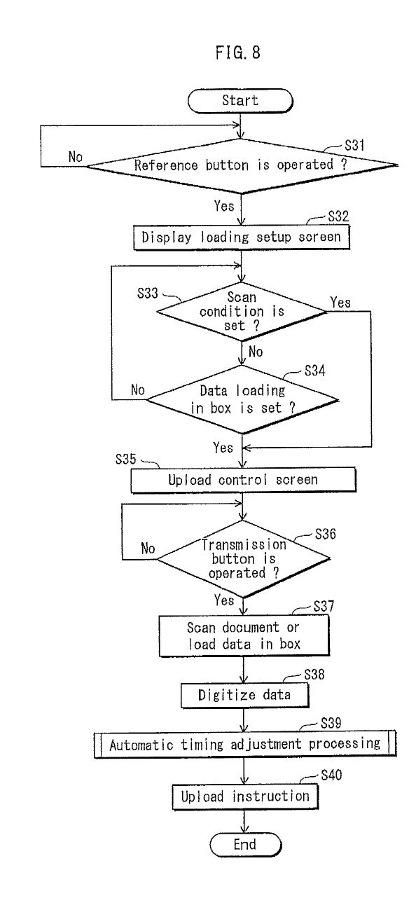

The following describes the second embodiment relating to an upload job of uploading image data acquired by the scanner 12 onto the web server 2, with reference to the flow chart shown in FIG. 8. In the present embodiment, in order to perform the upload job, the control unit 15 displays, on the display panel 13, the upload control screen 13a acquired from the web server 2. If the user operates the reference button 13e in such a status (see Step S31 in FIG. 8, hereinafter the same shall apply), the control unit 15 displays the loading setup screen 13b on the display panel 13, unlike in the first embodiment (Step S32). If a scan condition of the scanner 12 for scanning an image of a document is set via the scan condition setup input screen 13c displayed on the loading setup screen 13b (Step S33: YES), or if a desired data file stored in the box 15d is selected on the box data loading setup input screen 13d (Step S34: YES), the control unit 15 displays the upload control screen 13a on the display panel 13 (Step S35). At this time, digitization processing has not been performed yet.

Then, if the transmission button 13f is operated by the user (Step S36: YES), and further if the scan condition of the scanner 12 for scanning the image of the document is set, the control unit 15 instructs the scanner 12 to scan the image of the document. If file data stored in the box 15d is selected, the control unit 15 loads the selected file data from the box 15d (Step S37).

Then, like in the first embodiment, the control unit 15 causes the data digitization block 15f to convert the image data scanned by the scanner 12 or the file data loaded from the box 15 into digitized data in a predetermined format (Step S38). The control unit 15 causes the automatic timing adjustment processing block 15g to automatically adjust a timing of uploading (Step S39). Then, the control unit 15 instructs the browser 21a to upload the data onto the web server 2 (Step S40).

In this way, according to the file upload processing of the present embodiment, when the user firstly operates the reference button 13e displayed on the upload control screen 13a, the loading setup screen 13b is displayed. The user sets the scan condition of the image of the document, or sets data file stored in the box 15d, and then operates the transmission button 13f. Taking this opportunity, the image data acquired by the scanner 12 or the file data loaded from the box 15d is automatically digitized, and the digitized data is uploaded onto the web server 2 by the browser 21a.

Accordingly, the user does not need to set an upload condition such as an upload destination. Also, the user can select data to be uploaded by operating the reference button 13e. Furthermore, even if the file is selected, the file has not been digitized until the user operates the transmission button 13f. As a result, even after the file is selected, the selected file is not digitized until the transmission button 13f is operated. Accordingly, the user does not need to wait near the MFP 1, until digitization of a file selected via operation of the reference button 13e starts and the digitization ends or until scanning of an image of a document by the scanner 12 starts and digitization of the image data ends. This dramatically enhances the user convenience.

### Third Embodiment Relating to Upload Job

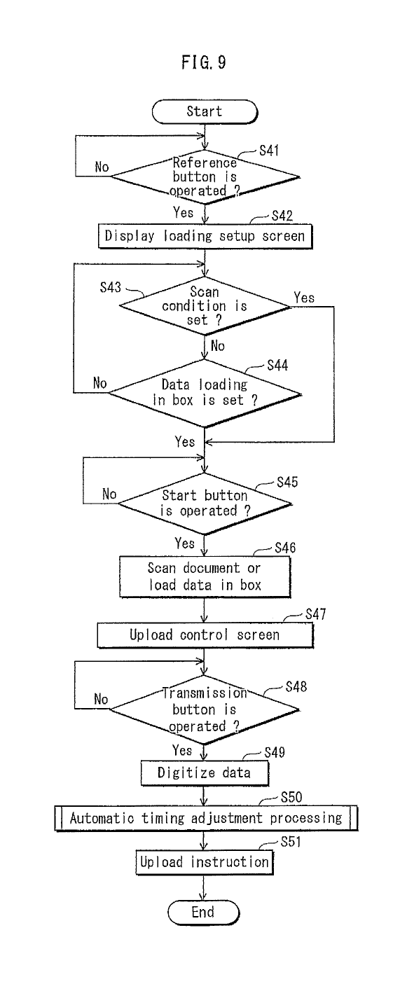

The following describes the third embodiment relating to the upload job performed by the MFP 1 of uploading the image data acquired by the scanner 12 onto the web server 2, with reference to the flow chart shown in FIG. 9.

In the upload job, when the upload control screen 13a is displayed on the display panel 13 and the reference button 13e is operated by the user (see Step S41 in FIG. 9, hereinafter the same shall apply), the loading setup screen 13b is displayed on the display panel 13, like in the second embodiment (Step S42). Then, if a scan condition of the scanner 12 for scanning an image of a document is set via the scan condition setup input screen 13c displayed on the loading setup screen 13b (Step S43: YES), or if a desired data file is selected from a list of data files stored in the box 15d displayed on the box data loading setup input screen 13d displayed on the loading setup screen 13b (Step S44: YES), the control unit 15 stands by until the user operates the start button 16 (Step S45). While the control unit 15 stands by until the user operates the start button 16, the user can change the scan condition or the selected file. The operation of the start button 16 means that the user has fixed the scan condition and the like.

Then, if the user operates the start button 16 (Step S45: YES), and further if the scan condition of the scanner 12 for scanning the image of the document is set, the control unit 15 instructs the scanner 12 to scan the image of the document. If the user operates the start button 16 (Step S45: YES), and further if the file data stored in the box 15d is selected, the scanner 12 loads the selected file data from the box 15d (Step S46).

Then, the control unit 15 displays the upload control screen 13a on the display panel 13 (Step S47). On the file name display field 13g, a file name of the image data scanned by the scanner 12 or a file name of the file data selected from the box 15d is displayed. At this time, the data has not been digitized yet. Then, the control unit 15 is in a standby status until the user operates the transmission button 13f (Step S48).

If the user operates the transmission button 13f in such a standby status (Step S48: YES), the control unit 15 causes the data digitization block 15f to convert the image data scanned by the scanner 12 or the file data loaded from the box 15d into digitized data in a predetermined format, like in the second embodiment (Step S49). The control unit 15 causes the automatic timing adjustment processing block 15g to automatically adjust a timing of uploading (Step S50). Then, the control unit 15 instructs the browser 21a to upload the data onto the web server 2 (Step S51).

As described above, according to the file upload processing relating to the third embodiment, firstly, the user operates the reference button 13e displayed on the upload control screen 13a, and sets a scan condition of an image of a document or selects a data file stored in the box 15d, and then operates the start button 16. As a result, image data generated by the scanner 12 is acquired or file data is loaded from the box 15d. At this time, a file name of the acquired image data or file data is displayed on the file name display field 13g of the upload control screen 13a. This enables the user to check data to be uploaded. Then, the user checks the data to be uploaded and operates the transmission button 13f. As a result, the image data generated by the scanner 12 or the file data loaded from the box 15d is automatically digitized, and the digitized data is uploaded onto the web server 2 by the browser 21a.

Accordingly, in the third embodiment, it is unnecessary for the user to wait near the MFP 1 until data to be uploaded onto the web server 2 is digitized. Also, it is possible to surely upload desired data onto the web server 2.

<Processing of Digitized Data>

The following describes processing of file upload job in the case where data digitized by the data digitization block 15f of the control unit 15 remains in the control unit 15 without being uploaded onto the web server 2.

If a predetermined job instructed by the user does not complete within a predetermined period, an auto reset function of the MFP 1 works. This function is for cancelling operations that have been already performed or instructions that have been already issued and is for performing initialization. Accordingly, in the first to third embodiments, if the user does not operate any one of the start button 16, the transmission button 13f, and the like after the image data of the document scanned by the scanner 12 is digitized, the auto reset function of the MFP 1 works due to the elapse of the predetermined period. As a result, the digitized data remains in the control unit 15 without being transmitted to the web server 2.

Also, in order to perform the upload job, the web server 2 performs authentication processing on the MFP 1. After the MFP 1 is authenticated, data digitized by the MFP 1 is uploaded onto the web server 2. If the upload job does not complete within a predetermined period, the server judges that the time runs out (time out), and as a result the web server 2 terminates the upload job. If scanning of the document by the scanner 12, digitization of the data or the like in the MFP 1 require a long period, uploading of the digitized data onto the web server 2 might not complete within the predetermined period and cause time out. In this case, the digitized data remains in the control unit 15 without being uploaded onto the web server 2. In the above both cases, the digitized data that has not been uploaded remains in the box 15d of the control unit 15, and this reduces the storage capacity of the box 15d. Also, there is a possibility that the remaining digitized data might be loaded and abused.

Accordingly, if the auto reset function of the MFP 1 works, or if the time out function of the web server 2 works, the MFP 1 performs processing on digitized data remaining in the control unit 15 using a method set in advance by the user.

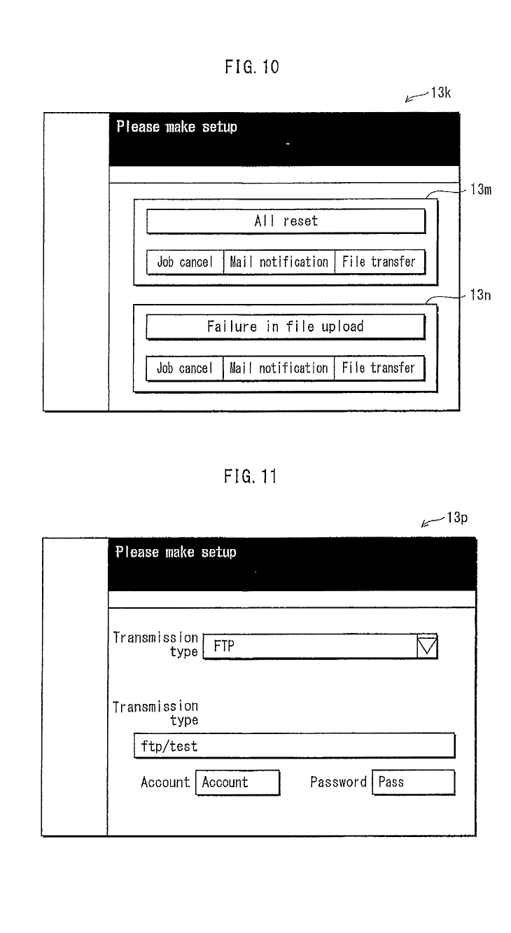

The method of processing digitized data is initialized by the user. When the user initializes the method of processing digitized data, a digitized data processing initialization screen 13k shown in FIG. 10 is displayed on the display panel 13. On the digitized data processing initialization screen 13k, an auto reset selection unit 13m and an upload failure selection unit 13n are displayed. The auto reset selection unit 13m is for selecting a method of processing digitized data remaining in the control unit 15 in the case where the MFP 1 is automatically reset. The upload failure selection unit 13n is for selecting a method of digitized data in the case where digitized data remains in the control unit 15 without being uploaded due to the time out of the web server 2.

On each of the auto reset selection unit 13m and the upload failure selection unit 13n, a job cancel button, an e-mail notification button, and a file transfer button are displayed. When any one of these buttons is operated by the user, any one of methods of job cancel processing, e-mail notification processing, file transfer processing is initialized by the digitized data processing block 15h of the control unit 15.

If the e-mail notification processing button displayed on the auto reset selection unit 13m or the upload failure selection unit 13n is operated and as a result the e-mail notification processing is selected, the PC 5 that has been authenticated in advance is set as a transmission destination, and a predetermined e-mail indicating that digitized data remains in the control unit 15 is transmitted to the PC 5.

Also, if the file transfer button displayed on the auto reset selection unit 13m or the upload failure selection unit 13n is operated and as a result the file transfer processing is selected, a file transfer setup screen 13p shown in FIG. 11 is displayed on the display panel 13, and a transfer destination of a file of digitized data is set. The transfer destination of the file in this case is, for example, a server 3 other than the web server 2, a PC, and a user box of other MFP. On the file transfer setup screen 13p, a transmission type (upper layer) input field of a file and a transmission type (lower layer) input field of the file, an account input field and a password input field for authenticating the user are displayed. This enables the user to input a transmission type and the like in a corresponding input field appropriately for the transfer destination. As a result, the transfer destination is initialized, and it becomes possible to transfer the file to the set transfer destination.

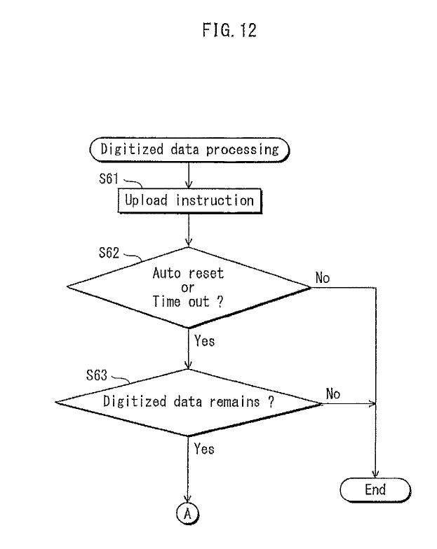

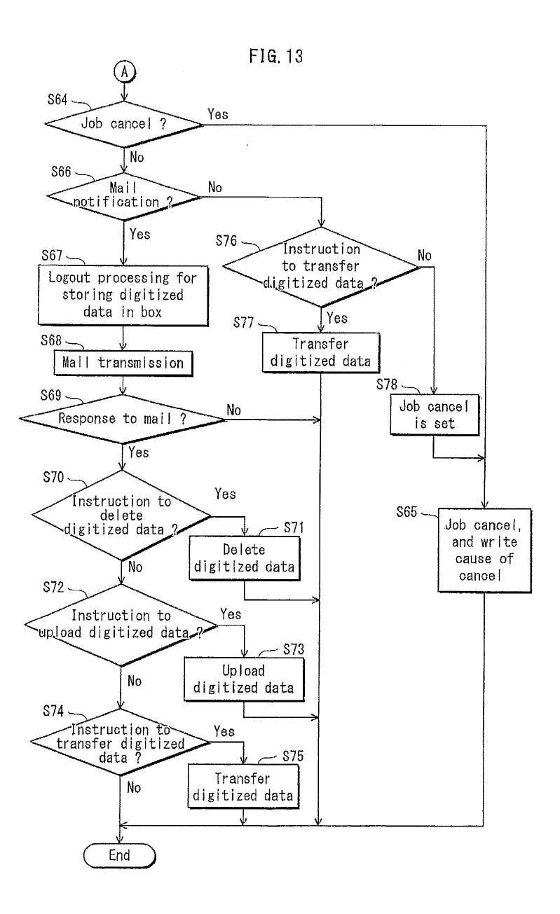

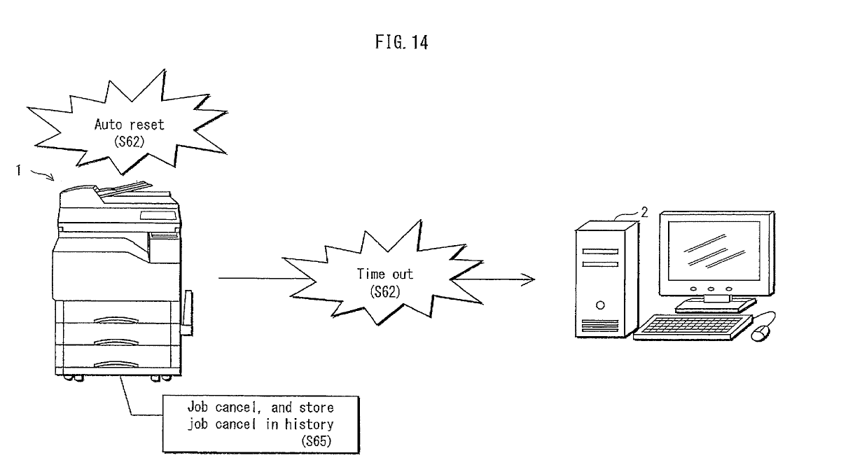

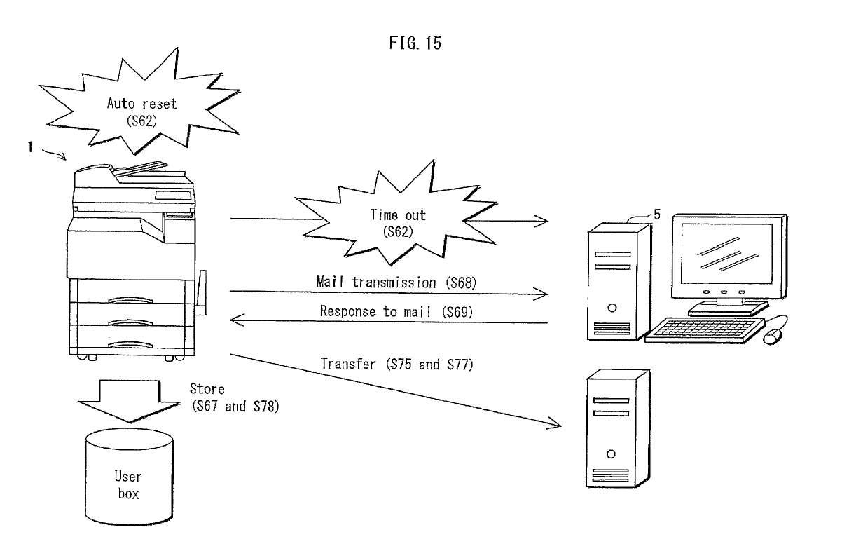

FIG. 12 and FIG. 13 are the flow charts showing processing of digitized data performed by the control unit 15. In the upload job, the control unit 15 instructs the browser 21a to upload digitized data onto the web server 2 (see Step S61 in FIG. 12, hereinafter the same shall apply). At the time when the auto reset function of the MFP 1 or the time out function of the web server 2 works (Step S62: YES), if data digitized by the data digitization block 15f remains in the control unit 15 without being uploaded onto the web server 2 (Step S63: YES), the control unit 15 performs any one of the initialized job cancel processing (see FIG. 14), the e-mail notification processing, and the file transfer processing (see FIG. 15).

If the job cancel processing is initialized by the digitized data processing block 15h (Step S64 in FIG. 13: YES), the control unit 15 cancels the upload job of uploading image data acquired by the scanner 12 onto the web server 2, and records a cause of the cancel (auto reset or time out) in the job history of the MFP 1 (see Step S65 and FIG. 14). As a result, digitized data remaining in the control unit 15 is deleted.

If the e-mail notification processing is initialized by the digitized data processing block 15h (Step S66: YES), the control unit 15 performs the logout processing of the MFP 1 to store digitized data in the box 15d (Step S67). Then, the control unit 15 transmits the above predetermined e-mail to the PC 5 of the authenticated user (Step S68). In this case, if receiving a response e-mail from the PC 5 of the authenticated user (Step S69: YES), the control unit 15 processes the digitized data in accordance with an instruction indicated by the response e-mail (see FIG. 15).

In other words, if the response e-mail instructs to delete the digitized data (Step S70: YES), the control unit 15 deletes the digitized data stored in the box 15d (Step S71). Also, if the response e-mail instructs to upload again the digitized data onto the web server 2 (Step S72: YES), the control unit 15 causes the browser 21a to upload again the digitized data stored in the box 15d onto the web server 2 (Step S73). Furthermore, if the response e-mail instructs to transfer the digitized data to a specified transfer destination (Step S74: YES), the control unit 15 transfers the digitized data stored in the box 15d to the specified transfer destination (Step S75). As a result, the digitized data is deleted from the box 15d of the MFP 1. The transfer destination in this case is, for example, a box of an authenticated PC and a box of other authenticated MFP, as described above. Also, if a response e-mail is not received even after a predetermine period has elapsed (Step S69: NO), the control unit 15 performs only the e-mail notification processing.

If the e-mail notification processing is not initialized as processing of digitized data by the digitized data processing block 15h (Step S66: NO), and further if the file transfer processing is set (Step S76: YES), the control unit 15 transfers the digitized data to a set predetermined transfer destination (Step S77). The transfer destination in this case is, for example, a server other than the web server, a PC of the authenticated user, and a user box of other MFP (see FIG. 15).

Note that any of the job cancel processing, the e-mail notification processing, and the file transfer processing is not initialized as processing of digitized data (Step S76: NO), the job cancel processing is initialized (Step S78), and the flow proceeds to Step S65. The control unit 15 cancels the upload job of uploading the image data acquired by the scanner 12 onto the web server 2, and records a cause of the cancel (auto reset or time out) in the job history of the MFP 1 (see Step S65 and FIG. 14). As a result, the digitized data remaining in the control unit 15 is deleted.

As described above, if data digitized by the data digitization block 15f remains in the control unit 15 without being uploaded onto the server 2 due to the auto reset of the MFP 1 or the time out of the web server 2, the control unit 15 performs predetermined processing such as deletion processing of the remaining data. This can suppress the decrease of the storage capacity due to the digitized data remaining in the control unit 15. Also, the deletion of the digitized data enables the remaining digitized data to be protected against the abuse.

Note that although an MFP has been described as an image formation apparatus including an image scanning apparatus in the above embodiments, the present invention is not limited to this. The present invention is applicable to an image formation apparatus such as a copier and a facsimile apparatus.

The present invention relates to an image processing apparatus including an image scanning unit, and is capable of improving users' convenience for causing a browser included in the image processing apparatus to upload image data scanned by the image scanning unit onto a web server.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. An image processing apparatus comprising:
a browser operable to acquire, from a web server, an upload control screen including a transmission receiving part that is operated for issuing an upload instruction, and upload digitized data in a predetermined format onto the web server via the operation of the transmission receiving part;
a storage that stores digitized data of a file;
an image scanner operable to scan an image of a document to generate digitized data of the image;
a display operable to display thereon the upload control screen;
a controller operable to, by using the operation of the transmission receiving part as a trigger, convert the digitized data of the file or the digitized data of the image into the predetermined format, and issue the upload instruction to the browser to upload the digitized data of the file or the digitized data of the image in the predetermined format.

2. The image processing apparatus of claim 1, wherein
after the transmission receiving part is operated, the controller acquires the digitized data of the image or the digitized data of the file, and performs the conversion.

3. The image processing apparatus of claim 2, further comprising
an acquisition instruction part that is operated for issuing an instruction to the controller to acquire the digitized data of the image or the digitized data of the file, wherein
after the transmission receiving part is operated, the controller issues a scan instruction to the image scanner to scan the image of the document or loads the digitized data of the file via the operation of the acquisition instruction part so as to acquire the digitized data of the image or the digitized data of the file.

4. The image processing apparatus of claim 3, wherein
a file name display field for displaying a file name of a selected file is displayed on the upload control screen,
if the file name display field is blank when the transmission receiving part is operated, the controller causes the display to display thereon a setup screen for setting a scan condition of the image scanner for scanning the image of the document or setting the digitized data of the file, and
the controller issues the scan instruction or loads the digitized data of the file based on the scan condition or digitized data of the file set via the setup screen.

5. The image processing apparatus of claim 2, wherein
the controller issues a scan instruction to the image scanner to scan the image of the document or loads the digitized data of the file via the operation of the transmission receiving part.

6. The image processing apparatus of claim 5, wherein
a reference receiving part that is operated for selecting a file to be uploaded is included in the upload control screen,
if the reference receiving part is operated before the transmission receiving part is operated, the controller causes the display to display thereon a setup screen for setting a scan condition of the image scanner for scanning the image of the document or setting loading of the digitized data of the file, and
the controller issues the scan instruction or loads the digitized data of the file based on the scan condition or loading of the digitized data of the file set via the setup screen.

7. The image processing apparatus of claim 1, wherein
before the transmission receiving part is operated, the controller acquires the digitized data of the image or the digitized data of the file.

8. The image processing apparatus of claim 7, further comprising
an acquisition instruction part that is operated for issuing an instruction to acquire the digitized data of the image or the digitized data of the file, wherein
if the acquisition instruction part is operated before the transmission receiving part is operated, the controller issues a scan instruction to the image scanner to scan the image of the document or loads the digitized data of the file so as to acquire the digitized data of the image or the digitized data of the file.

9. The image processing apparatus of claim 8, wherein
a reference receiving part that is operated for selecting a file to be uploaded is included in the upload control screen,
if the reference receiving part is operated before the transmission receiving part is operated, the controller causes the display to display thereon a setup screen for setting a scan condition of the image scanner for scanning the image of the document or setting loading of the digitized data of the file, and
the controller issues the scan instruction or loads the digitized data of the file based on the scan condition or loading of the digitized data of the file set via the setup screen.

10. The image processing apparatus of claim 1, wherein
the controller automatically adjusts a timing of issuing the upload instruction to the browser so as to conform to a predetermined timing.

11. The image processing apparatus of claim 10, wherein
the controller automatically adjusts the timing at one of a time immediately after the digitized data of the image or the digitized data of the file is converted into the predetermined format, a time immediately after a specified time after the conversion, and a time immediately after the image processing apparatus completes image processing instructed by a user and logs out.

12. The image processing apparatus of claim 1, wherein
if the digitized data of the image or the digitized data of the file converted into the predetermined format remains in the controller when the image processing apparatus is automatically reset or when the web server is timed out, the controller performs predetermined processing on the remaining digitized data.

13. The image processing apparatus of claim 12, wherein
the controller is set in advance to perform one of processing of cancelling the upload instruction, processing instructed by a response e-mail to an e-mail transmitted to a predetermined authenticated user, and processing of transferring the digitized data of the image or the digitized data of the file converted into the predetermined format to the predetermined authenticated user.
